(19) United States
(12) Patent Application Publication
(10) Pub. No.: US 2014/0181002 A1
(43) Pub. Date: Jun. 26, 2014

(54) Systems and Methods for Implementing Virtual Cubes for Data Processing

(71) Applicant: SAS INSTITUTE INC., Cary, NC (US)

(72) Inventors: Stacey M. Christian, Cary, NC (US); Donald Erdman, Raleigh, NC (US); Steven Krueger, Raleigh, NC (US)

(73) Assignee: SAS INSTITUTE INC., Cary, NC (US)

(21) Appl. No.: 13/721,162

(22) Filed: Dec. 20, 2012

(51) Int. Cl. G06F 17/30

(52) U.S. Cl. CPC G06F 17/30292
USPC 707/600; 707/793

(57) ABSTRACT

System and methods are provided for processing a multi-dimensional data structure represented as multi-dimensional cubes. A first multi-dimensional cube and a second multi-dimensional cube are received, the first multi-dimensional cube including first cube property data and first user data, the second multi-dimensional cube including second cube property data and second user data. A virtual multi-dimensional cube including virtual cube property data for accessing and performing computer-based operations upon the first user data and the second user data are generated, the virtual cube property data including a first mapping from the first cube property data to the virtual cube property data and a second mapping from the second cube property data to the virtual cube property data.

### FIELD

The present disclosure relates generally to data processing and, more specifically, to computer-implemented systems and methods for processing multi-dimensional data structures.

### BACKGROUND

On-line Analytical Processing (OLAP) technology may enable users to analyze multi-dimensional data. Some applications of OLAP include business reporting for sales, marketing, management reporting, forecasting, and financial reporting. Large amounts of data can be analyzed for OLAP applications, and such data can be organized into multi-dimensional data cubes. Sometimes, each dimension of a multidimensional cube may represent a different type of data.

### SUMMARY

In accordance with the teachings described herein, systems and methods are provided for processing a multi-dimensional data structure represented as multi-dimensional cubes. A first multi-dimensional cube and a second multi-dimensional cube may be received, the first multi-dimensional cube including first cube property data and first user data, the second multi-dimensional cube including second cube property data and second user data. A virtual multi-dimensional cube including virtual cube property data for accessing and performing computer-based operations upon the first user data and the second user data may be generated, the virtual cube property data including a first mapping from the first cube property data to the virtual cube property data and a second mapping from the second cube property data to the virtual cube property data.

For example, a third multi-dimensional cube is received, the third multi-dimensional cube including third cube property data. The third cube property data is combined into the virtual cube property data, the virtual cube property data further including a third mapping from the third cube property data to the virtual cube property data. The first multi-dimensional cube includes one or more first dimensions, a first dimension including one or more first dimension levels, the first cube property data including information associated with the first dimensions and the first dimension levels. The second multi-dimensional cube includes one or more second dimensions, a second dimension including one or more second dimension levels, the second cube property data including information associated with the second dimensions and the second dimension levels. As another example, the virtual multi-dimensional cube includes one or more virtual dimensions corresponding to the first dimensions and the second dimensions, a virtual dimension including one or more virtual dimension levels corresponding to the first dimension levels and the second dimension levels.

In one example, the first mapping includes data associated with mapping the first dimensions to the virtual dimensions and data associated with mapping the first dimension levels to the virtual dimension levels. The second mapping includes data associated with mapping the second dimensions to the virtual dimensions and data associated with mapping the second dimension levels to the virtual dimension levels. In another example, the first multi-dimensional cube includes an on-line analytical processing (OLAP) cube, and the second multi-dimensional cube includes an on-line analytical processing (OLAP) cube. Data of the first multi-dimensional cube is stored on one or more first nodes in a first connected grid of computers, and data of the second multi-dimensional cube is stored on one or more second nodes in a second connected grid of computers.

As an example, the virtual cube property data includes information selected from the group consisting of locations of the first user data and the second user data, version information of a software used to create the virtual multi-dimensional cube, information associated with the first nodes and the second nodes, output variables, a list of class variables, a number of horizons, and cash flow dates. The virtual multi-dimensional cube and the virtual cube property data are dynamically updated in response to the first multi-dimensional cube or the second multi-dimensional cube being updated. Data related to the first multi-dimensional cube and the second multi-dimensional cube is stored in a memory when the virtual multi-dimensional cube is generated.

In another embodiment, a computer-implemented system is provided for processing a multi-dimensional data structure represented as multi-dimensional cubes. The example system may include one or more data processors, and a computer-readable storage medium encoded with instructions for commanding the data processors to execute operations. The operations may include, receiving a first multi-dimensional cube and a second multi-dimensional cube, the first multi-dimensional cube including first cube property data and first user data, the second multi-dimensional cube including second cube property data and second user data, and generating a virtual multi-dimensional cube including virtual cube property data for accessing and performing computer-based operations upon the first user data and the second user data, the virtual cube property data including a first mapping from the first cube property data to the virtual cube property data and a second mapping from the second cube property data to the virtual cube property data.

In yet another embodiment, a non-transitory computer readable medium comprising programming instructions is provided for processing a multi-dimensional data structure represented as multi-dimensional cubes. The programming instructions may be configured to cause a processing system to execute the following operations, receiving a first multi-dimensional cube and a second multi-dimensional cube, the first multi-dimensional cube including first cube property data and first user data, the second multi-dimensional cube including second cube property data and second user data, and generating a virtual multi-dimensional cube including virtual cube property data for accessing and performing computer-based operations upon the first user data and the second user data, the virtual cube property data including a first mapping from the first cube property data to the virtual cube property data and a second mapping from the second cube property data to the virtual cube property data.

### BRIEF DESCRIPTION OF THE DRAWINGS

FIG. 1 illustrates an example of a three-dimensional data cube.

FIG. 2 illustrates an example of a data cube.

FIG. 3 illustrates an example of a virtual cube.

FIG. 4 illustrates an example of metadata contained in the virtual cube, as shown in FIG. 3.

FIG. 5 illustrates an example of mappings contained in the metadata, as shown in FIG. 4.

FIG. 6 illustrates an example of a flow chart for processing a multi-dimensional data structure represented as multi-dimensional cubes.

FIG. 7 depicts an example of a computer-implemented environment wherein users can interact with a multi-dimensional data structure processing system hosted on one or more servers through a network.

FIG. 8 depicts an example of a multi-dimensional data structure processing system provided on a stand-alone computer for access by a user.

### DETAILED DESCRIPTION

Data cubes are convenient and flexible mechanisms for representing multidimensional data, but some problems remain. For example, consider a company having multiple divisions with data from each division represented by a data cube. Though data of a particular division may be accessed and analyzed using the corresponding data cube, a complete cube view and cross-cube analysis of the entire company is often not available. When combining data, for example, data cubes of different divisions may have different dimensions, or a same dimension of two data cubes may include different hierarchy levels. Even if data of all divisions can be combined into a single cube, data of these divisions may be finalized at different times during a day.

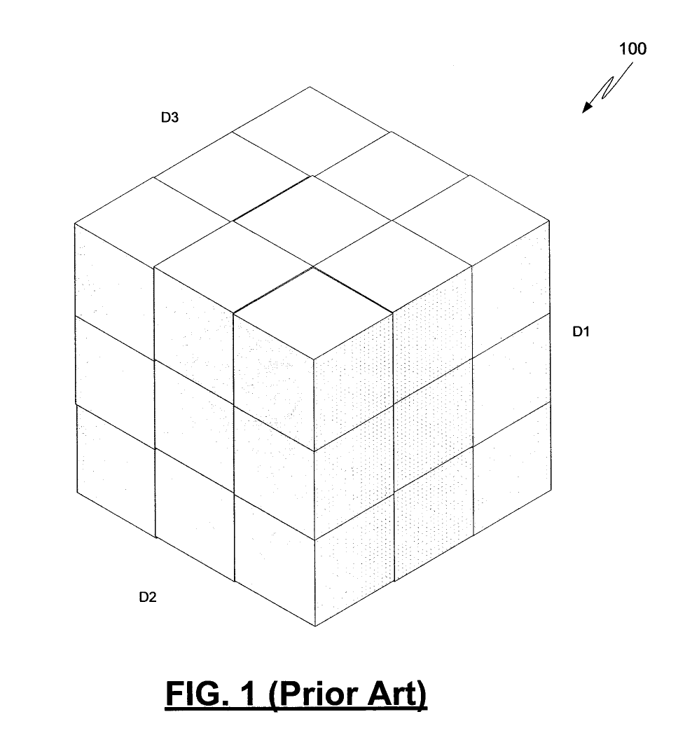

FIG. 1 illustrates an example of a three-dimensional data cube. The cube 100 includes three dimensions D1, D2, and D3. For example, the cube 100 can be used to store travel expense data of a company. The dimension D1 of the cube 100 may specify travel costs, the dimension D2 may specify time, and the dimension D3 may specify divisions of the company. Hence, data in a particular cell of the cube may indicate the travel costs by a particular division of the company during a particular period of time (e.g., a year). A dimension of the cube 100 may include one or more levels. For example, the time dimension D2 may consist of days, weeks, months, and years.

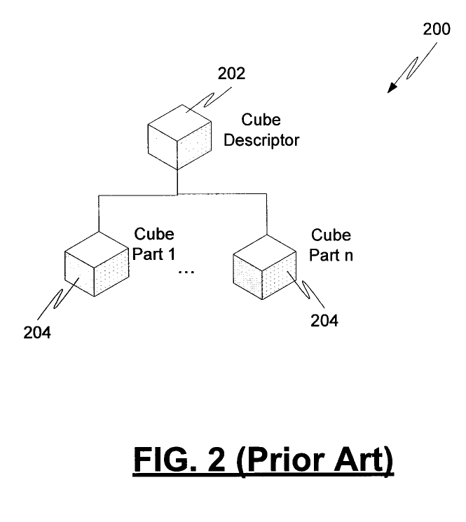

Often, OLAP data cubes are created and used in one or more memory devices (e.g., random-access memory devices) which may span multiple nodes in a connected grid of machines. FIG. 2 illustrates an example of a data cube. The cube 200 includes one or more cube parts 204 which contain user data, and a cube descriptor 202 which contains metadata about the cube parts 204, such as where the cube parts 204 are located and what applications/software is needed for opening the cube and deleting the cube. Once the cube parts 204 are loaded into memory devices, aggregation and computation of statistics can be performed.

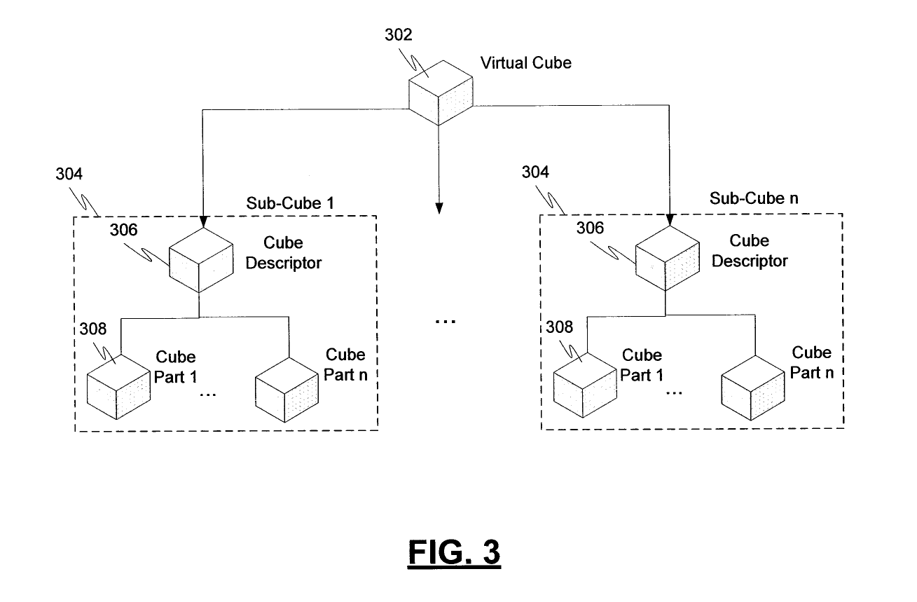

FIG. 3 illustrates an example of a virtual cube. As shown in FIG. 3, the virtual cube 302 is a logical representation of one or more multi-dimensional sub-cubes 304. The sub-cubes 304 may be accessed and analyzed through the virtual cube 302, so that cross-cube access and analysis of the sub-cubes 304 can be performed. Specifically, the virtual cube 302 includes metadata about the sub-cubes 304, such as the dimensions of the data cubes 304, levels of a dimension in the data cube 304, where the cubes 304 are located, and what applications/software is needed for opening the cubes 304 and deleting the sub-cubes 304, etc. In addition, the virtual cube 302 may include mappings from metadata of the sub-cubes 304 to metadata of the virtual cube 302. The virtual cube 302 may point to cube descriptors 306 of the sub-cubes 304, instead of the cube parts 308 of the sub-cubes 304.

An example syntax for generating the virtual cube 302 to join the sub-cubes 304 is as follows:

proc hprisk
TASK = JOINCUBES
CUBE = “c:\mycubes\er_cube.tkeitem”
SUBCUBES =(“c:\mycubes\mr_cube ”
“c:\mycubes\cr_cube ”
“c:\mycubes\alm_cube ”
);
;
run; quit;

The sub-cubes 304 may be created independently at different times or in parallel, which provides flexibility to perform different tasks. For example, a company may create an initial large sub-cube that represents a portfolio of assets of the company. During a particular time period, sub-cubes representing changes to the portfolio can be created. A virtual cube can be generated to join the subsequent sub-cubes with the initial sub-cube to represent the updated portfolio of the company. In another example, a company desires an enterprise view of the business risks. Sub-cubes may be generated to represent risks along different lines of business (e.g., market risk and credit risk). Then, a virtual cube may be created to join these sub-cubes to provide an enterprise view of the company. In yet another example, sub-cubes can be created regularly (e.g., every day, every month) to represent risks (e.g., Value at Risk) of a company. A virtual cube may be created to join these sub-cubes continuously. Then, managers can monitor risk spikes over time through the virtual cube. Further, a virtual cube that joins one or more sub-cubes may be updated when a new version of a sub-cube becomes available. Each sub-cube in the virtual cube may include metadata for the creation time. Thus when the virtual cube is accessed, the staleness of the data contained in the sub-cubes can be indicated.

The metadata of the sub-cubes 304 may be different from each other because these sub-cubes may include different user data (e.g., measures, outputs), different dimensions and different dimension levels. The metadata of the virtual cube 302 may be generated by joining/mapping the metadata of the sub-cubes 304.

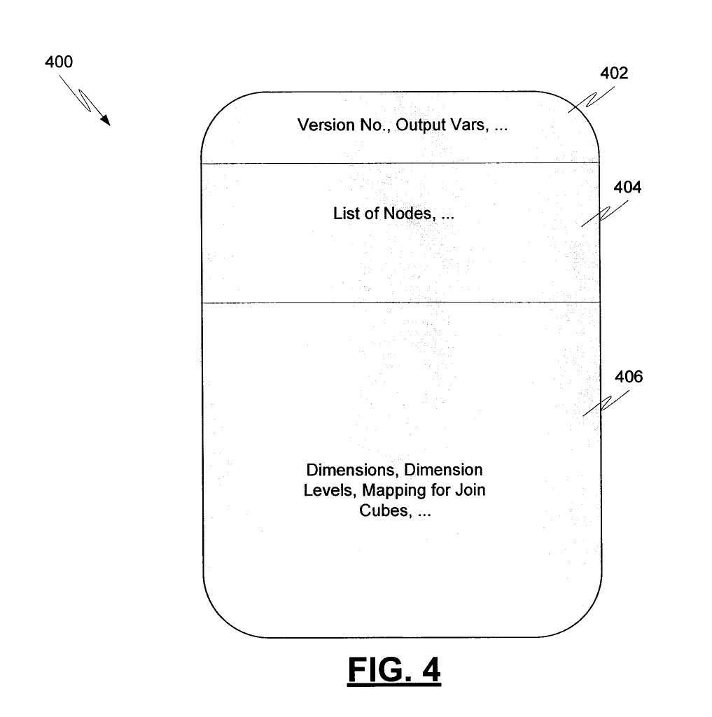

FIG. 4 illustrates an example of metadata contained in a virtual cube. As shown in FIG. 4, the metadata 400 of the virtual cube includes three parts 402, 404, and 406. The first part 402 includes scalar information about the sub-cubes. For example, the first part 402 contains information of a software (e.g., a version number of the software) used for creating sub-cubes, the number of nodes used to create the sub-cubes, output variables of the sub-cubes, a list of classification variables, the number of horizons, cash flow dates, and physical paths on hard drive disks for the sub-cubes. The second part 404 includes a list of nodes which contain part of the sub-cubes. Network names of these nodes may be included in the list. The third part 406 includes dimension-related data of the sub-cubes. For example, the third part 406 contains information associated with the dimensions of the sub-cubes, the levels of the dimensions in the sub-cubes, and mappings for linking the dimension levels of the sub-cubes.

For example, the sub-cubes represent forecast data made every day during a week. Each of the sub-cubes may include a number of dimensions representing different business lines. Thus, the metadata of the virtual cube may include a list of these dimensions. As another example, the sub-cubes may include overlapping dimensions, while dimension levels for these overlapping dimensions vary among the sub-cubes. The metadata 400 may merge these dimension levels of the sub-cubes to generate a list of different dimension levels. In addition, mappings between the generated list and the dimension levels of each of the sub-cubes may be created.

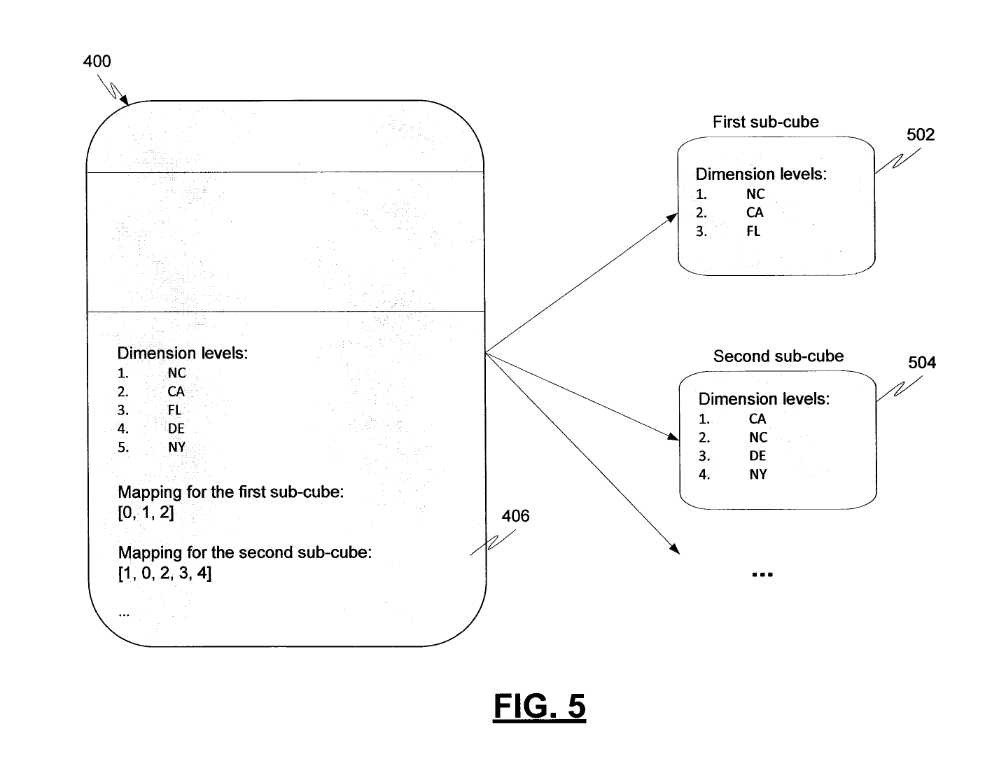

FIG. 5 illustrates an example of mappings contained in the metadata 400. As shown in FIG. 5, the metadata 400 includes mappings of the dimension levels of the sub-cubes. For example, among the sub-cubes, a sub-cube 502 and a sub-cube 504 both have a “Location” dimension. The sub-cube 502 has three ordered levels in the “Location” dimension, such as NC, CA, and FL. The sub-cube 504 has four ordered levels in the “Location” dimension, such as CA, NC, DE, and NY. Thus, the sub-cube 504 has more dimension levels than the sub-cube 502, and the overlapped dimension levels of these two sub-cubes are in different orders. The third part 406 of the metadata 400 may include a list of ordered dimension levels, such as NC, CA, FL, DE and NY. In addition, the third part 406 of the virtual cube includes mappings for the sub-cube 502 and the sub-cube 504. For example, the mapping for the sub-cube 502 contains an array of integers [0 1 2], where “0” represents the first dimension level in the list of the order dimension levels, i.e., NC, “1” represents the second in the list, i.e., CA, and “2” represents the third in the list, i.e., FL. The mapping for the sub-cube 504 includes another array of integers [1 0 2 3 4] indicating the ordered dimension levels of the sub-cube 504 are CA, NC, DE and NY.

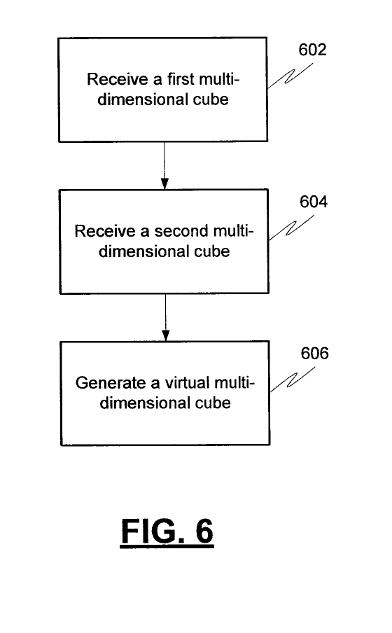

FIG. 6 illustrates an example of a flow chart for processing a multi-dimensional data structure represented as multi-dimensional cubes. As shown in FIG. 6, a first multi-dimensional cube and a second multi-dimensional cube are received at operations 602 and 604, respectively. The first multi-dimensional cube includes first cube property data and first user data, the second multi-dimensional cube includes second cube property data and second user data. A virtual multi-dimensional cube is generated at operation 606. The virtual multi-dimensional cube includes virtual cube property data for accessing and performing computer-based operations upon the first user data and the second user data. The virtual cube property data includes a first mapping from the first cube property data to the virtual cube property data and a second mapping from the second cube property data to the virtual cube property data.

As an example, consider a company having 3000 banking books which are finalized at different times during a business day. A complete cube view of the whole company is desired before all of the banking books are finalized. A sub-cube may be created for each banking book, and each sub-cube may take less than 30 seconds to put on a connected grid of computers. It takes less than 15 minutes to upload all 3000 banking books. It takes less than 1 second to create a virtual cube to join the 3000 sub-cubes. A particular sub-cube may be updated during the business day. The virtual cube may then be updated by joining the 2999 sub-cubes that are not updated and the updated sub-cube.

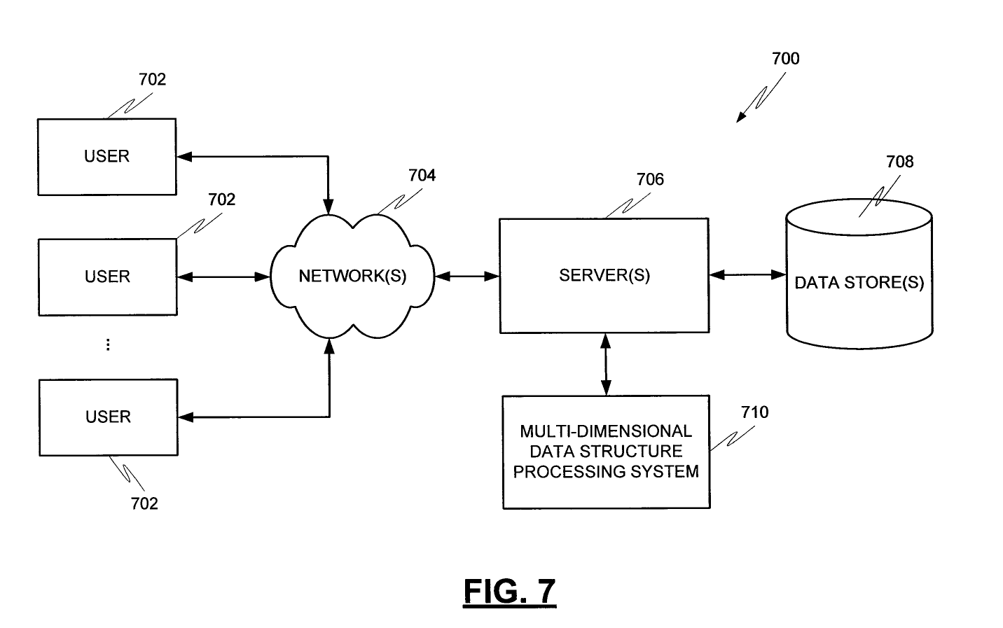

FIG. 7 illustrates an example of a computer-implemented environment wherein users 702 can interact with a multi-dimensional data structure processing system 710 hosted on one or more servers 706 through a network 704. Data in a multi-dimensional data structure is often represented as multi-dimensional cubes. The multi-dimensional data structure processing system 710 can assist the users 702 to implement a virtual cube for processing multiple data cubes. For example, the virtual cube may be created to join the multiple data cubes, and cross-cube access and analysis may be performed on the data cubes.

As shown in FIG. 7, the users 702 can interact with the multi-dimensional data structure processing system 710 through a number of ways, such as over one or more networks 704. One or more servers 706 accessible through the network(s) 704 can host the multi-dimensional data structure processing system 710. The one or more servers 706 can also contain or have access to one or more data stores 708 for storing data for the multi-dimensional data structure processing system 710.

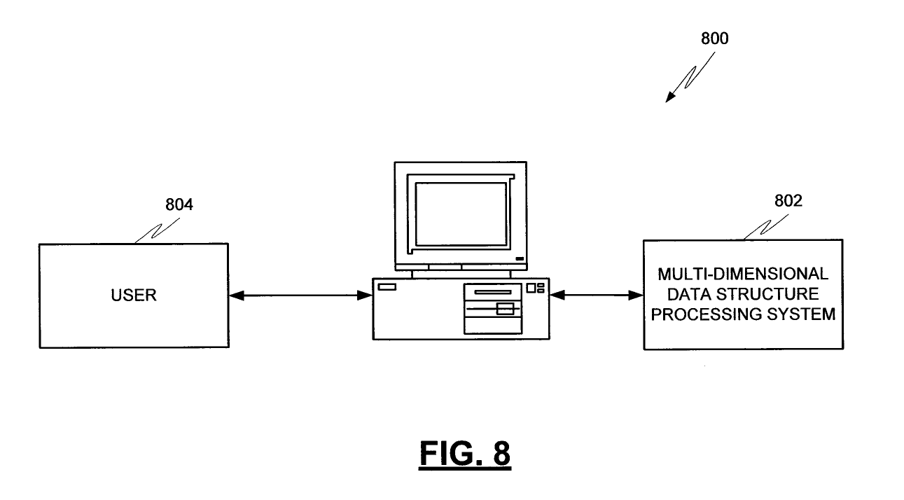

The examples used in this disclosure can vary. For example, a computer-implemented system and method can be configured for performing real time incremental Value at Risk (VaR) analysis. As another example, a computer-implemented system and method can be configured for combining data cubes with different outputs, such as a credit risk data cube and a market risk data cube, or combining data cubes with different horizons. As another example, a computer-implemented system and method can be configured for creating a virtual cube that may require little space and can be updated throughout a business day. As another example, a computer-implemented system and method can be configured such that a multi-dimensional data structure processing system 802 can be provided on a stand-alone computer for access by a user, such as shown at 800 in FIG. 8.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims. For example, the actions recited in the claims can be performed in a different order and still achieve desirable results.

It is claimed:

1. A computer-implemented method for processing a multi-dimensional data structure represented as multi-dimensional cubes, said method comprising:
receiving a first multi-dimensional cube and a second multi-dimensional cube, the first multi-dimensional cube including first cube property data and first user data, the second multi-dimensional cube including second cube property data and second user data; and
generating, with one or more processors, a virtual multi-dimensional cube including virtual cube property data for accessing and performing computer-based operations upon the first user data and the second user data, the virtual cube property data including a first mapping from the first cube property data to the virtual cube property data and a second mapping from the second cube property data to the virtual cube property data.

2. The method of claim 1, and further comprising:
receiving a third multi-dimensional cube, the third multi-dimensional cube including third cube property data; and
combining the third cube property data into the virtual cube property data, the virtual cube property data further including a third mapping from the third cube property data to the virtual cube property data.

3. The method of claim 1, wherein:
the first multi-dimensional cube includes one or more first dimensions, a first dimension including one or more first dimension levels, the first cube property data including information associated with the first dimensions and the first dimension levels; and
the second multi-dimensional cube includes one or more second dimensions, a second dimension including one or more second dimension levels, the second cube property data including information associated with the second dimensions and the second dimension levels.

4. The method of claim 3, wherein the virtual multi-dimensional cube includes one or more virtual dimensions corresponding to the first dimensions and the second dimensions, a virtual dimension including one or more virtual dimension levels corresponding to the first dimension levels and the second dimension levels.

5. The method of claim 4, wherein:
the first mapping includes data associated with mapping the first dimensions to the virtual dimensions and data associated with mapping the first dimension levels to the virtual dimension levels; and
the second mapping includes data associated with mapping the second dimensions to the virtual dimensions and data associated with mapping the second dimension levels to the virtual dimension levels.

6. The method of claim 1, further comprising utilizing:
the first multi-dimensional cube including an on-line analytical processing (OLAP) cube; and
the second multi-dimensional cube including an on-line analytical processing (OLAP) cube.

7. The method of claim 6, wherein:
data of the first multi-dimensional cube is stored on one or more first nodes in a first connected grid of computers; and
data of the second multi-dimensional cube is stored on one or more second nodes in a second connected grid of computers.

8. The method of claim 7, wherein the virtual cube property data includes information selected from the group consisting of locations of the first user data and the second user data, version information of a software used to create the virtual multi-dimensional cube, information associated with the first nodes and the second nodes, output variables, a list of class variables, a number of horizons, and cash flow dates.

9. The method of claim 1, further comprising dynamically updating the virtual multi-dimensional cube and the virtual cube property data in response to the first multi-dimensional cube or the second multi-dimensional cube being updated.

10. The method of claim 1, wherein data related to the first multi-dimensional cube and the second multi-dimensional cube is stored in a memory when the virtual multi-dimensional cube is generated.

11. A computer-implemented system for processing a multi-dimensional data structure represented as multi-dimensional cubes, said system comprising:
one or more data processors;
a computer-readable storage medium encoded with instructions for commanding the data processors to execute operations including:
receiving a first multi-dimensional cube and a second multi-dimensional cube, the first multi-dimensional cube including first cube property data and first user data, the second multi-dimensional cube including second cube property data and second user data; and
generating a virtual multi-dimensional cube including virtual cube property data for accessing and performing computer-based operations upon the first user data and the second user data, the virtual cube property data including a first mapping from the first cube property data to the virtual cube property data and a second mapping from the second cube property data to the virtual cube property data.

12. The system of claim 11, wherein the programming instructions are configured to cause the data processors to execute further operations comprising:
receiving a third multi-dimensional cube, the third multi-dimensional cube including third cube property data; and
combining the third cube property data into the virtual cube property data, the virtual cube property data further including a third mapping from the third cube property data to the virtual cube property data.

13. The system of claim 11, wherein:
the first multi-dimensional cube includes one or more first dimensions, a first dimension including one or more first dimension levels, the first cube property data including information associated with the first dimensions and the first dimension levels; and
the second multi-dimensional cube includes one or more second dimensions, a second dimension including one or more second dimension levels, the second cube property data including information associated with the second dimensions and the second dimension levels.

14. The system of claim 13, wherein the virtual multi-dimensional cube includes one or more virtual dimensions corresponding to the first dimensions and the second dimensions, a virtual dimension including one or more virtual dimension levels corresponding to the first dimension levels and the second dimension levels.

15. The system of claim 14, wherein:
the first mapping includes data associated with mapping the first dimensions to the virtual dimensions and data associated with mapping the first dimension levels to the virtual dimension levels; and
the second mapping includes data associated with mapping the second dimensions to the virtual dimensions and data associated with mapping the second dimension levels to the virtual dimension levels.

16. The system of claim 11, wherein:
the first multi-dimensional cube includes an on-line analytical processing (OLAP) cube; and
the second multi-dimensional cube includes an on-line analytical processing (OLAP) cube.

17. The system of claim 16, wherein:
data of the first multi-dimensional cube is stored on one or more first nodes in a first connected grid of computers; and
data of the second multi-dimensional cube is stored on one or more second nodes in a second connected grid of computers.

18. The system of claim 17, wherein the virtual cube property data includes information selected from the group consisting of locations of the first user data and the second user data, version information of a software used to create the virtual multi-dimensional cube, information associated with the first nodes and the second nodes, output variables, a list of class variables, a number of horizons, and cash flow dates.

19. The system of claim 11, wherein the virtual multi-dimensional cube and the virtual cube property data are dynamically updated in response to the first multi-dimensional cube or the second multi-dimensional cube being updated.

20. A non-transitory computer readable medium comprising programming instructions for processing a multi-dimensional data structure represented as multi-dimensional cubes, the programming instructions configured to cause a processing system to execute operations comprising:
receiving a first multi-dimensional cube and a second multi-dimensional cube, the first multi-dimensional cube including first cube property data and first user data, the second multi-dimensional cube including second cube property data and second user data; and
generating a virtual multi-dimensional cube including virtual cube property data for accessing and performing computer-based operations upon the first user data and the second user data, the virtual cube property data including a first mapping from the first cube property data to the virtual cube property data and a second mapping from the second cube property data to the virtual cube property data.
